(19) United States
(12) Patent Application Publication
(10) Pub. No.: US 2025/0217852 A1
(43) Pub. Date: Jul. 3, 2025

(54) SYSTEM AND METHOD FOR DYNAMIC ASSIGNMENT OF MACHINE READABLE CODES FOR ONLINE INFORMATION ACCESS

(71) Applicant: Randall G. SCOTT, Cambridge (CA)

(72) Inventor: Randall G. SCOTT, Cambridge (CA)

(21) Appl. No.: 19/005,558

(22) Filed: Dec. 30, 2024

Related U.S. Application Data
(60) Provisional application No. 63/616,431, filed on Dec. 29, 2023.

(51) Int. Cl. G06Q 30/0241; G06K 7/14; G06Q 10/20

(52) U.S. Cl. CPC G06Q 30/0277; G06Q 10/20; G06K 7/1417

(57) ABSTRACT

The present system and method is directed to a solution for dynamically assigning a machine readable code for directing traffic to information online. In an embodiment, the system scans a machine readable code, recognizes an account code associated with the machine readable code, verifies an authorized user associated with the account code, receives instructions to activate the machine readable code, receives instructions to assign the machine readable code to a system user specified landing page, and activates a link from the machine readable code to the user specified landing page upon request from the system user.

### CROSS-REFERENCE TO RELATED APPLICATIONS

The present application claims the benefit of U.S. Provisional Application No. 63/616,431 entitled SYSTEM AND METHOD FOR DYNAMIC ASSIGNMENT OF MACHINE READABLE CODES FOR ONLINE INFORMATION ACCESS and filed on Dec. 29, 2023, and the benefit of U.S. Provisional Application No. 63/704,536 entitled SYSTEM AND METHOD FOR DYNAMIC ASSIGNMENT OF MACHINE READABLE CODES FOR ONLINE INFORMATION ACCESS and filed on Oct. 7, 2024, which are incorporated by reference herein in their entirety.

### FIELD

This disclosure relates to machine readable codes, and for using such codes to provide online information access.

### BACKGROUND OF THE INVENTION

The popularity of using machine readable codes for accessing information online on the Internet has exploded in recent years, and it is now common to see machine readable codes displayed on signage or labels, or electronically displayed on a screen, to direct a user to a webpage, for example, to learn more information about a product or service that is associated with the machine readable signage or label. One such machine readable code system for directing traffic to a particular website URL is known as a QR Code®, which is a registered trademark in the U.S., by Denso Wave Incorporated (Japan). While the use of machine readable codes, such as the QR Code, is a very effective way to direct traffic to a website, it does have some significant limitations, as once the QR code has been printed, the destination URL is set.

What is needed is a system and method which will overcome at least some of these limitations in the prior art.

### SUMMARY OF THE INVENTION

The present system and method is directed to a solution for dynamically assigning a machine readable code for directing traffic to information online. For example, the information may contain additional details about a product or service associated with the machine readable code which is scanned by an end user.

In an embodiment, the present system and method enables machine readable codes to be pre-printed on high-quality physical labels that are placed with, or directly on a product. For example, and not by way of limitation, a high-quality label printed in color and including a brand logo and a dealer logo may be affixed to an automobile which is on display on a show room floor at a car dealership, or perhaps displayed at a large auto show. If a label or signage is not placed directly on the vehicle such as to a side window, the label or signage may appear on a display stand adjacent to or placed near the vehicle, for example.

Each pre-printed machine readable code is accompanied by a unique account code which is used by the present system and method to uniquely identify the machine readable code with an account code, which in turn is associated with an online account accessible by a system user through a user interface associated with the unique account code.

In an embodiment, a system user is given access to an account code associated with a series of pre-printed machine readable labels, and the system user is able to associate each specific machine readable code and an associated unique account code to a particular online landing page, which may contain additional information about a product or service. The system user is also able to delete and update the associations, such that a pre-printed label or sign with a machine readable code and a unique account code can be reassigned to a different online landing page, and reused for a different product or service. The information on each associated landing page can also be updated or changed, for example to update a price during a sales event, for example.

This association of a machine readable code and an account code to a desired information landing page is transparent to the end user who has scanned the machine readable code, as they are connected directly with the information landing page which a system user has associated with the machine readable code and unique account code.

In another embodiment, once a pre-printed machine readable code is associated with an account code and assigned to an online landing page, the machine readable code may be utilized by multiple authorized parties to access information on the online landing page that is updated periodically about an item associated with the machine readable code. By way of example, and not by way of limitation, the machine readable code may be affixed to a vehicle and allow multiple authorized parties including the vehicle manufacturer, the dealership which sold the vehicle, and various third party service providers to access the maintenance history for the vehicle provided on the online landing page.

In another embodiment, the pre-printed machine readable code may be associated with an account code and assigned to an online landing page which tracks information about a consumer anonymously. By way of example, and not by way of limitation, the pre-printed machine readable codes may be placed on bottles of expensive liquor or other valuable items, and which allows a consumer to update information on an online landing page which provides the consumer with the ability to anonymously collect reward points by associating multiple pre-printed machine readable codes on an online landing page. The liquor company is able to track and collect detailed information about consumers of its products, while proving consumers with the anonymity they may seek which may otherwise stop them from sharing information. It will be appreciated that this may be done for any item of significant value, which a vendor may wish to promote to consumers seeking anonymity.

Advantageously, the use of unique account codes allows system users to dynamically assign the online information landing page to which traffic is directed when the machine readable code is scanned from the label or signage, allowing high flexibility in associating the machine readable code to any number of website URLs after the machine readable code has been pre-printed.

### BRIEF DESCRIPTION OF DRAWINGS

The present invention, and the objects of the invention will become apparent when consideration is given to the following detailed description thereof. Such description makes reference to the annexed drawings, wherein:

FIG. 1 shows an example of a label or signage associated with a product or service in accordance with an illustrative embodiment.

FIG. 2 shows a schematic diagram of how a series of pre-printed labels are directed to and associated with an online account to which a user is granted access.

FIG. 3 shows a schematic diagram of a user interface for associating each unique account code with information specific to each product or service.

FIG. 4 shows a schematic flow chart of a method in accordance with an embodiment.

FIG. 5 shows a schematic block diagram of a generic computer device which may provide an operating environment for various embodiments of the system.

FIG. 6 shows an illustrative example of a user interface screen for activating a label in accordance with an embodiment.

FIG. 7 shows an illustrative example of a promotional page in accordance with an embodiment.

FIG. 8 shows an illustrative example of a graph for tracking all active labels during a time period.

FIG. 9 shows an illustrative example of reports that can be created from information tracked by the activated label and associated tracking information.

FIG. 10 shows an illustrative example of another embodiment, in which machine readable codes provided on vehicles are used for tracking vehicle maintenance.

FIG. 11 shows an illustrative example of another embodiment, in which machine readable codes can be associated with each other to target a promotional offer anonymously.

### DETAILED DESCRIPTION OF THE INVENTION

As noted above, the present system and method is directed to a solution for dynamically assigning a machine readable code for directing traffic to an online landing page, which may contain additional information about a product or service associated with the machine readable code.

In an embodiment, the present system and method enables machine readable codes to be pre-printed on high-quality physical labels that are placed with or on a product. For example, and not by way of limitation, a high-quality label printed in color and including a brand logo and a dealer logo may be affixed to an automobile which is on display on a show room floor at a car dealership. If not directly on the vehicle, such as a label attached to a side window of the vehicle, the label or signage may appear on a display stand adjacent to or near the vehicle, for example.

Each pre-printed machine readable code is accompanied by a unique account code which is used by the present system and method to uniquely identify the machine readable code with an account code, which in turn is associated with an online account user interface associated with the unique account code.

In an embodiment, a user is given access to an account code for a series of pre-printed machine readable labels, and the user is able to directly associate each specific machine readable code and associated unique account code to a particular online landing page, for a specific product. The user is also able to break and update the associations, such that a pre-printed label or sign with a machine readable code and a unique account code can be reassigned to a different online landing page and reused for a different unique product or service. The information on each associated landing page can also be updated or changed, for example to update a price during a sales event, for example.

Advantageously, the use of unique account codes allows users to dynamically assign or reassign an online landing page that traffic is directed to when the machine readable code is scanned from the label, allowing extreme flexibility in associating the machine readable code to any number of website URLs that contain more information about the product.

Various illustrative embodiments will now be described with reference to the drawings.

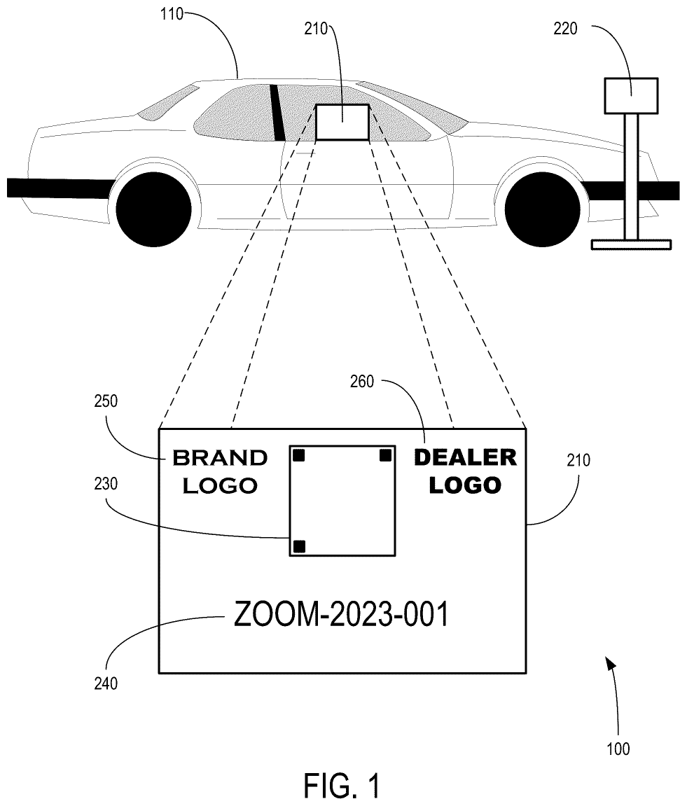

Referring to FIG. 1, shown is an example of a label or signage associated with a product or service in accordance with an illustrative embodiment 100. As shown, a label 210 is placed on a product or service, which in this example is an automobile 110 at an auto convention, or shown in a dealer showroom. The label or signage could also be placed adjacent to or near the product or service, as shown by example at signage 220 placed near the automobile 110. An enlarged closeup of the label 210 shows a machine readable code 230, which is suitable for scanning using a camera on a smartphone, for example. By way of example, and not by way of limitation, the machine readable code 230 may be a QR Code®, which is a trademark in the U.S., registered by Denso Wave Incorporated (Japan), which directs a user to an online resource or landing page, such as an Internet website URL. Other machine readable codes (e.g. using a smartphone) that can direct a user to an online resource or landing page, such as an Internet website URL, may also be used.

The label 210 may be printed on high quality stock, including color printed logos or brands, which in this illustrative example may include a brand logo 250, and a dealer logo 260. Other relevant information may be included.

Still referring to FIG. 1, the label 210 also includes an account code 240, which in this case may include an account ID, as well as a serial number for the account ID. In this illustration, the account code 240 comprises an account ID “ZOOM-2023”, and an illustrative 3-digit serial number “-001”. It will be appreciated that there may be any number of digits for the serial number, depending on the number of labels which have been pre-printed for the account ID.

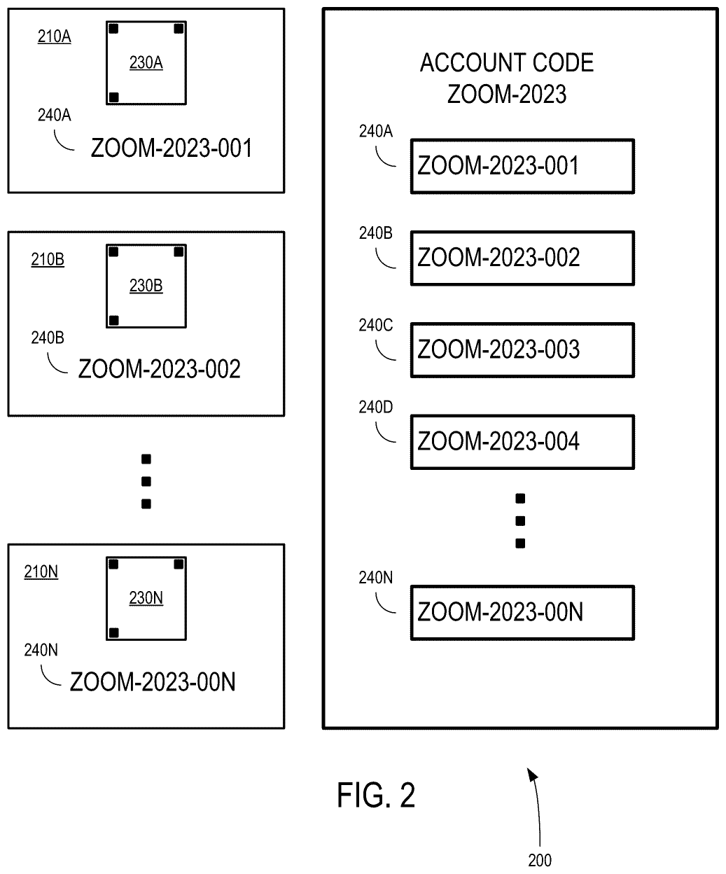

Now referring to FIG. 2, shown is a schematic diagram 200 of how a series of pre-printed labels 210A-210N are directed to and associated with an online account, here account ID “ZOOM-2023”, to which a user is granted access. In this illustration, each of the labels 210A-210N include unique machine readable codes 230A-230N which direct traffic to the user account “ZOOM-2023”. Each of the labels also have an account code 240A-240N which uniquely identify the machine readable code 230A-230N to each unique account code 240A-240N. As described above, each account code includes an account ID, and a serial number corresponding to the unique account code for a product or service. Upon accessing the account, all of the labels created for the account ID “ZOOM-2023” become available for an authorized user to associate with information that is unique for a given product or service.

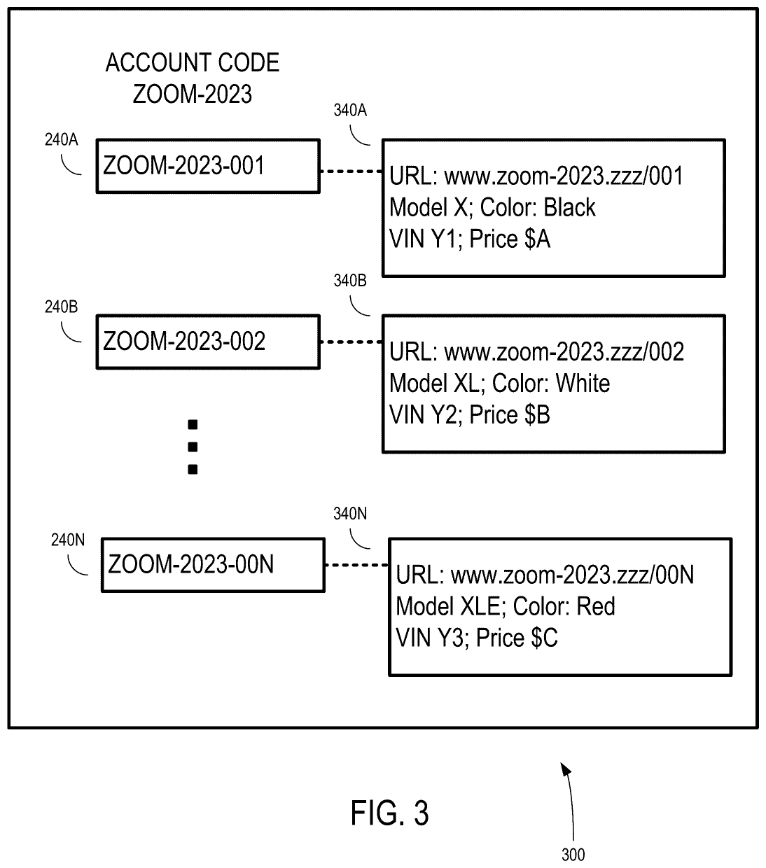

Now referring to FIG. 3, shown is a schematic diagram 300 of a user interface for associating each unique account code 240A-240N with information files 340A-340N specific to each unique product or service. In this illustration, the information files 340A-340N may include the URL for the specific landing page, and other pertinent information for the product or service, in this case an automobile, including its model name, color, vehicle identification number or VIN, and the price, whether an MSRP price or a sale price set by the dealer. The information file 340A-340N may include any other relevant information for the product or service, and the information file may be edited such that any updates become available in real-time when traffic is directed to it by one of the machine readable codes 230A-230N.

Advantageously, the present system and method allows personal account user information to be protected, as the machine readable code 230A-230N only directs traffic to the system, and the particulars of the account code are known only to the system. An authorized user of the account is then able to make any further association of each machine readable code to a specific landing page.

In an embodiment, the authorized user of the account ID can activate or deactivate access to a landing page at any time, such that when traffic is directed to a landing page, it may receive a temporary message that the page is not available if access is temporarily turned off. This may be useful if some critical information, such as a sale price, needs to be updated. Once a link is activated, any end user scanning the code will have a seamless experience, and be directed to the specific landing page associated to the account code by the authorized user. Since this association is done dynamically by the user, and not embedded into the machine readable code, the account code allows the authorized user to associate a landing page, update information on the landing page, and control access to the landing page at will, in real time.

In an embodiment, the system and method tracks traffic directed to each specific landing page from a scanned machine readable code 230A-230N, and the compiled report is made available to an authorized user of the account. Once a prospective customer is accessing a unique landing page, various parameters may be tracked to report on what information a user is viewing. The landing page may also request contact information, such as an email address or a telephone number, if a prospective customer wishes to be contacted about the product or service.

Based on the information available on the landing page, if a transaction is completed through this online channel, the specific information file for a unique product or service can be used to track a sale, including MSRP and sold price, and any other details relating to the sale, so that the information can be collected and become available for sales and marketing intelligence purposes. For items for which it is important to track the time the item remains in inventory, the system can track when an account serial number became live, and when it was deactivated after a sale to calculate the total number of days to make a sale. If there are a number of different locations, sales and marketing information can be collected by location to see which models are selling best at which location.

Advantageously, the present system and method allows high quality labels to be printed in bulk, such that it is cost effective. For example, if a car dealership wishes to print labels for all of its vehicles in stock, which may be many dozens of vehicles or perhaps hundreds of vehicles at one time, then they could pre-print as many high quality labels as required, place a label on each vehicle in inventory or as they come onto the lot, and then subsequently associate each label with particular information specific to a vehicle only after the fact.

While the use of these labels for automobiles has been described by way of example, it will be appreciated that this concept could be expanded to virtually any business in which products or services could be identified with high quality pre-printed labels, which may then be associated after the fact as the pre-printed labels are placed on the products. For example, in appliance stores, such labels could be placed on individual appliances—whether washers, dryers, ovens, fridges, dishwashers, etc.—and associated only after the fact by an authorized user who associates the label with a unique landing page with an information file specific to each appliance. Furniture stores could also employ these pre-printed labels in a similar way. Conventions or showrooms for boats, RVs, motorcycles, off road vehicles, etc. may also employ these labels.

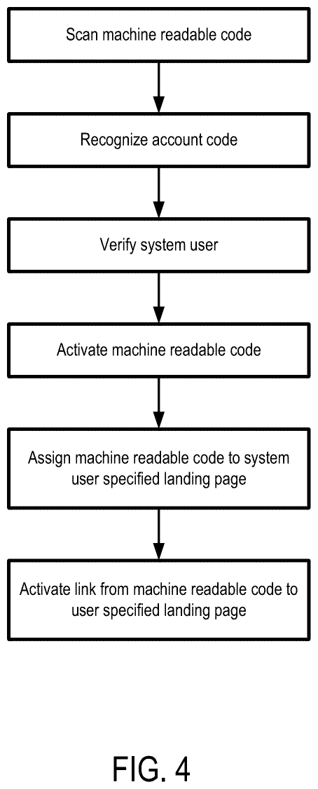

Now referring to FIG. 4, shown is an illustrative method 400 in accordance with an embodiment.

As shown, at block 402, the system scans a machine readable code, such as a QR Code, to direct an end user to the system server URL. This is done every single time. At block 404, the system then recognizes an alpha numeric account code associated with the QR Code, and identifies a system user account associated with the account code. At block 406, as a safety precaution, the system verifies that the system user is properly authorized. This may involve verifying a system userid and password, and completing a two-factor authentication process with a verification code sent by email or by text, for example.

Still referring to FIG. 4, at block 408, the verified system user activates the QR Code, and assigns the QR Code to a specific online information landing page. The particular landing page may be virtually any landing page selected by the system user, but the system may include safety controls to verify that the landing page is authentic, and does not attempt to further redirect an end user to another webpage, for example. This may be done by having the system user create the landing pages through their system account, so that the landing pages can be verified as they are created or as they are updated.

Still referring to FIG. 4, at block 410, once the authorized system user has associated the QR Code on the label or signage with the landing page, the authorized system user can save the information and request the system to activate the link. Optionally, the system may initiate a payment process in order to activate the link, but if the labels and links are prepaid by the system user, the system may fulfill the request to activate the link without any further step required. This process is transparent to the end user scanning the QR Code, and the access to the online information landing page is completed almost instantly, as if there was no redirect.

Advantageously, the method above allows system users to have a large number of high quality labels and signage with QR codes printed and on hand. When a system use wants to use one of the labels, they login to the system, get verified as an authentic user, activates a machine readable code, associates a landing page with the machine readable code, then requests activation of the link. This greatly increases the usability of machine readable codes, such as QR Codes, by allowing a system user to assign landing pages associated with the machine readable codes simply by making an association through a simple user interface, without any programming knowledge or reprinting of machine readable codes required.

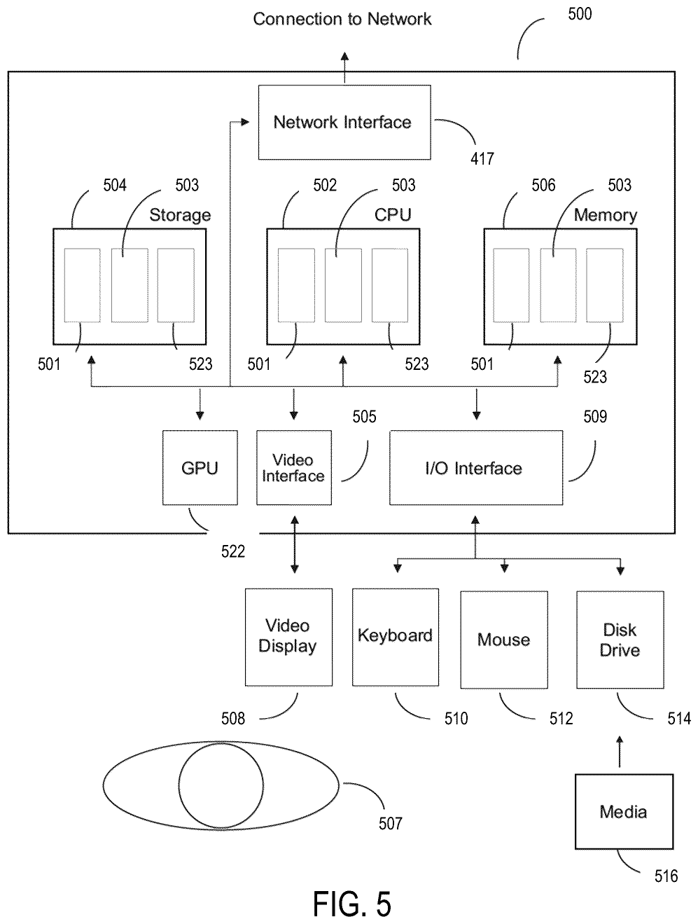

Now referring to FIG. 5 shown is a schematic block diagram of a generic computing device 500 that may provide a suitable operating environment in one or more embodiments. A suitably configured computer device, and associated communications networks, devices, software and firmware may provide a platform for enabling one or more embodiments as described above. By way of example, FIG. 5 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive calculations (including, but not limited to image processing or inference or training of deep learning Al models) from CPU 502 and run these calculations in parallel with CPU 502. An operator 510 may interact with the computer device 500 using a video display 508 connected by a video interface 505, and various input/output devices such as a keyboard 510, pointer 512, and storage 514 connected by an I/O interface 509. In known manner, the pointer 512 may be configured to control movement of a cursor or pointer icon in the video display 508, and to operate various graphical user interface (GUI) controls appearing in the video display 508. The computer device 500 may form part of a network via a network interface 511, allowing the computer device 500 to communicate with other suitably configured data processing systems or circuits. A non-transitory medium 516 may be used to store executable code embodying one or more embodiments of the present method on the generic computing device 500.

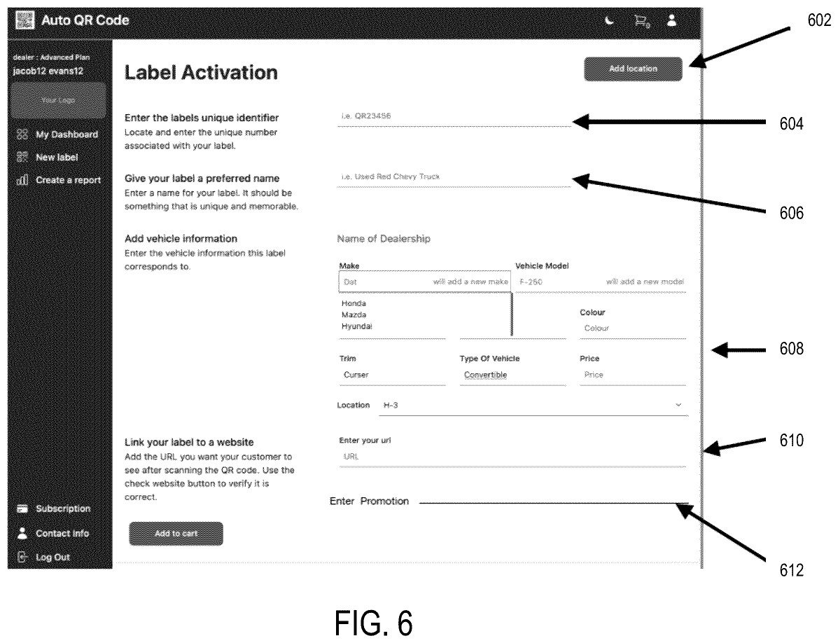

Now referring to FIG. 6, shown is an illustrative example of a system user interface screen for activating a label in accordance with an embodiment. At 602, a location, such as a dealership lot where a vehicle having an activated label is located, can be specified. At 604, a unique account code 240 associated with the system user can be specified, and the system checks that the system user is allowed to edit this label and associated machine readable code. If the system user does not have permission to activate and edit this machine readable code on a label, then the system will deny access. At 606, the system user can give the machine readable code a Name which they will recognize to identify the label from a list. For example, this may be a descriptive name for the particular vehicle with which the activated label is associated.

Still referring to FIG. 6, at 608, the system allows the system user to identify all of the attributes of the vehicle. This example is just illustrative, and additional attributes can be added at any point. Advantageously, these attributes can be tracked right from the system, such that the system user can request tracking of these attributes directly from the labels, rather than from a separate URL file associated with the vehicle.

Still referring FIG. 6, at 610, the system user can define which Internet URL a machine readable code directs the end user to when the machine readable code is scanned. This can be edited by the system user at any time.

Finally, at 612, the system has the ability to direct the end user who scans the machine readable code to another page, such as an offer page also associated with the machine readable code. For example, if the end user is willing to share personal contact information and accepts, the system can bring up this offer page at which the end user can provide their personal information, in exchange for an offer provided at the promotional page. Afterwards, the end user can be taken to the main URL page specified at 610.

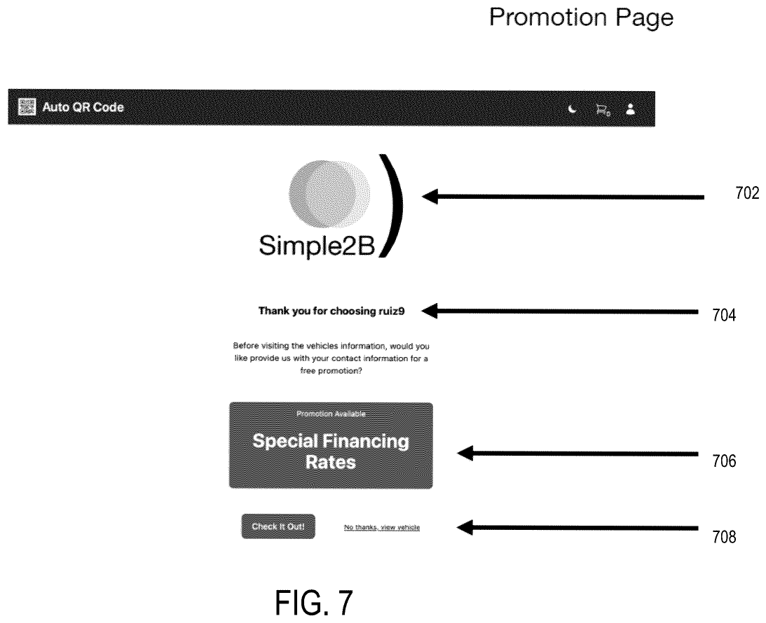

Now referring to FIG. 7, shown is an illustrative example of an associated promotional page described above. At 702, the system will insert the logo of a company offering the promotion. At 704, the system will enter the company name and a promotional message. At 706, the special offer is made, such as a special financing rate in this particular example. At 708, the system provides an option to the end user to choose this offer or to bypass it.

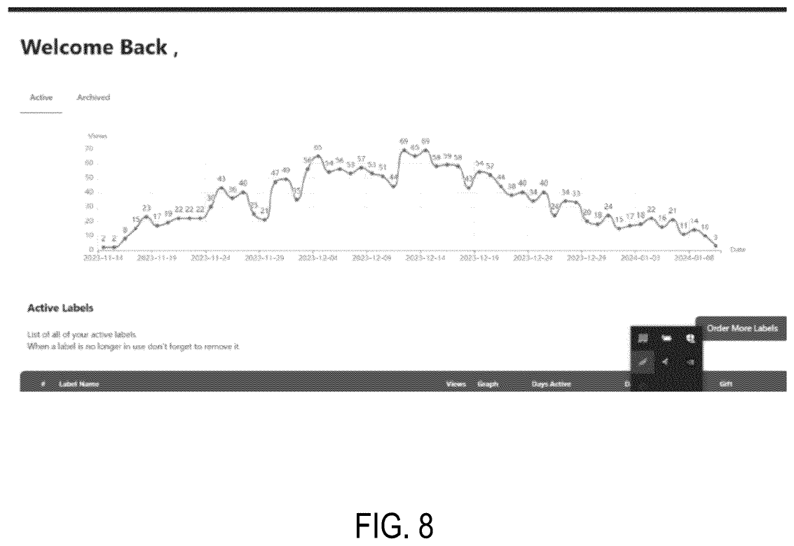

Now referring to FIG. 8, shown is an illustrative example of a graph for tracking all active labels during a time period. In this example, the total number of labels that are active time can be tracked by the system. For example, this graph may represent the on-site vehicle inventory over a period of time, as represented by the by the number of activated labels.

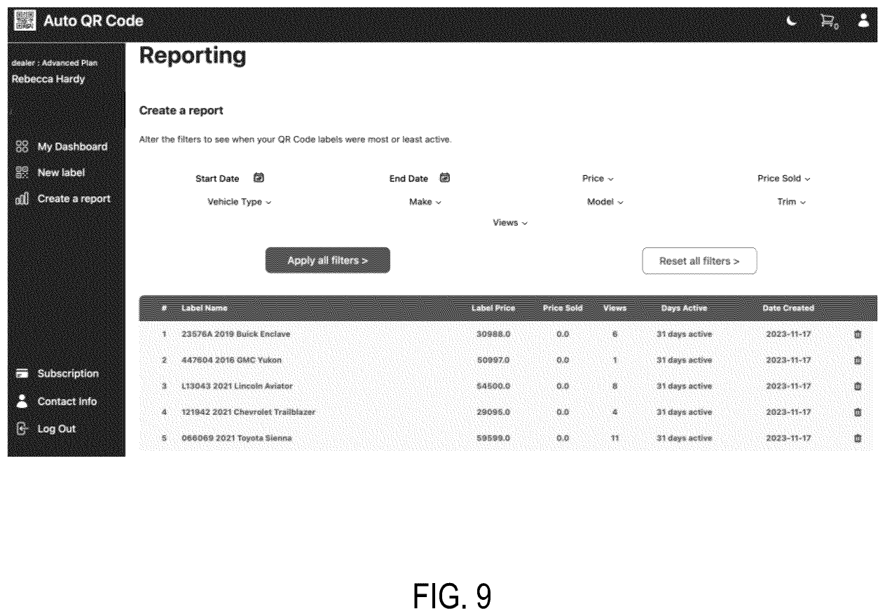

Now referring to FIG. 9, shown is an illustrative example of reports that can be created from information tracked by the activated label and associated tracking information. For example, any of the attributes that were specified for each vehicle at 608 above may be tracked individually, or in whichever groups that may make sense. In this illustrative example, each particular label that has been created is tracked individually to represent the number of days a vehicle spent on the lot before being sold. Thus, the total number of days a label was active represents the number of days it tool for a vehicle to be sold off the lot.

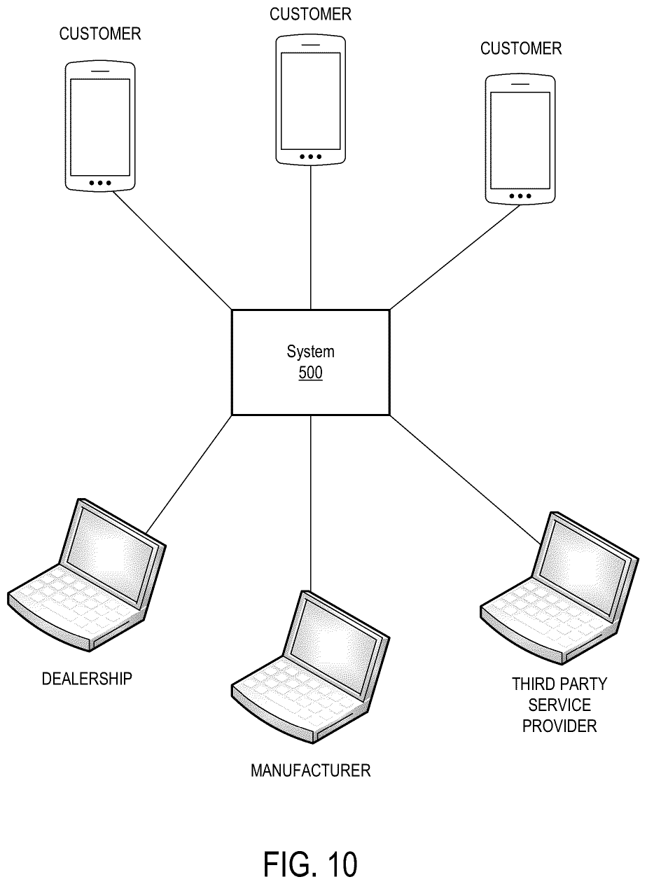

Now referring to FIG. 10, in another embodiment, there is provided a system and method for tracking vehicle maintenance records by providing a unique machine readable code with each vehicle. More specifically, the system and method can be adapted to create incentives to maintain a vehicle with a national program that registers maintenance done by certified technicians on each vehicle, regardless of where the maintenance work is done. Typically, during an initial period where a vehicle is under full warranty, the maintenance is done at a dealership. However, once the full warranty coverage expires, a vehicle owner will typically consider other options which may be less expensive.

Even while a vehicle is under a full warranty, in some cases, the work that needs to be done may be urgent, and a dealership may not have immediate capacity to attend to the work. In such a case, the vehicle owner may engage a technician at a third party shop to attend to the urgently required work. Should this occur, the maintenance fee work is typically not tracked by the home dealership, and a vehicle maintenance history may be incomplete.

However, by using a machine readable code for entering and tracking a vehicle's maintenance history, a complete vehicle maintenance history can be tracked and secured regardless of who performed the work.

In an embodiment, once a vehicle's maintenance history is logged, authorized parties can scan the machine readable code associate with the vehicle to access its maintenance history. As will be describe below, this vehicle maintenance record can be used a number of different ways, including by providing full maintenance records for a vehicle owner (and a potential buyer) for a higher resale price.

In an embodiment, the system and method includes establishing a network of vehicle service shops and certified technicians who can register for free to scan the unique machine readable code of a vehicle to access the full history of vehicle maintenance information. This allows any service shop to see the vehicle maintenance history and the work that was done at any participating location, thus allowing each of them to make a more informed decision on what type of servicing a vehicle requires.

From a dealer perspective, while they may no longer be an exclusive service provider for maintaining a vehicle, the vehicle maintenance history allows them to see what work was done at third party shops—whether small independent service shops or larger chains—in order to better track the vehicle maintenance history, for example to verify any warranty claims as may be necessary. Furthermore, if a dealer knows that certain specific types of maintenance services are coming up, then they could attempt to woo back a customer by providing timed advertisements for maintenance service specials.

Advantageously, this allows precision targeted ads to go out to each vehicle owner regardless of where they have been seeking vehicle maintenance services (e.g. oil change). Such criteria including vehicle type, the estimated odometer reading, and the timing for a next scheduled service can be used to customize a targeted ad for each vehicle owner based on the type of service that is next coming up.

In an embodiment, the system and method tracks where a vehicle has been serviced such that they allow a dealership to see how a vehicle owner is obtaining maintenance services, and allow them to make service pricing decisions accordingly to woo back some of their customers.

In an embodiment, the system and method provides the tracking information on an aggregated basis to show how much business is being lost by each dealership to other service providers. This may allow a vehicle manufacturer to assist their dealership network in how they can retain for service business by helping them understand their clients better.

From the third party shop's perspective, sharing the maintenance information provides them with access to vehicle maintenance data, and allows them to continue to compete for the work as well. However, the third party shops need not provide any sensitive competitive information, such as pricing information or promotional discounts, which they would not want to share. Instead, they would simply provide sufficient information to describe what work was done—e.g. an X thousand mile/kms oil change, X thousand mile/kms brake service, tire change/balancing/etc. The third parties themselves could also offer coupons, discounts, etc. and provide reminders to the customer to compete with the dealership.

In an embodiment, the manufacturer may also provide an incentive for third party service providers, for example by providing access to certain manufacturer incentive programs which may allow third party service providers to order genuine parts at a discount in exchange for sharing vehicle maintenance service details through the system. As a complete vehicle history also helps the manufacturer gain valuable data, proving such incentives may make sense for the manufacturer as well.

Still referring to FIG. 10, in another embodiment, the system and method also allows a vehicle owner or customer to scan the same unique machine readable code associated with the vehicle in order to access their vehicle maintenance history, and to provide them with any reminders for upcoming maintenance services that need to be scheduled. Given that the dealership now has access to a full maintenance history, the dealership can provide a full list of mandatory maintenance required on the specific vehicle, when it is due, and reminders along with a status showing 100% up to date, or behind in one or more maintenance tasks.

In an embodiment, a built in scheduling feature allows the customer to book maintenance services by either accepting a maintenance service offer with a calendar showing available dates and times, or by sending a request to schedule a maintenance service in response to such an offer. This allows a dealership or other service provider to schedule a maintenance service more easily, and to potentially offer the customer additional services such as vehicle cleaning or detailing.

In an embodiment, a customer can schedule a drop off of their vehicle and also tie this to a car rental if the vehicle must be left at the service station. Advantageously, this allows other services to be automatically scheduled in conjunction with the service appointment.

In an embodiment, the system and method allows for a work order to be created based on the maintenance services that a customer selects. If the customer has selected any optional services such as cleaning or detailing, these services can be automatically added to the work order and billed accordingly. If certain costs cannot be determined until after a service has been performed, the work order can provide an estimate, with a note that the actual amount will be billed after work has been completed. The invoice can be prepared and, with the customer's authorization, fully paid for before vehicle pickup in order to provide a seamless experience.

In an embodiment, once a service has been completed, the system and method can provide a full list of upcoming mandatory maintenance services, and a list of suggested services going forward. The system and method can then offer to send a reminder to the customer to book an appointment for an upcoming service with sufficient lead time so that a scheduled maintenance task is not missed.

In another embodiment, the system and method allows a mechanic to communicate with a customer directly during a service session. The mechanic can upload a photo showing an issue along with an explanation, and suggest extra services that are recommended. If the client agrees, the services are added to the work order, and the invoice is automatically updated. If the client declines a service, the system and method can record that the technician recommended a service which was declined by a customer in case this is disputed at a later time.

Advantageously, the system and method provides a way to track a complete vehicle maintenance history even beyond the initial warranty period, such that the vehicle health and status is up to date at all times. It allows a car manufacturer and its dealership network to provide incentives to customers to return to the dealership for servicing, and also allows any recall notices requiring servicing to be sent directly to a known current contact, rather than address information that may be out of date. For the customer, a complete vehicle history is accessible online, and can be provided to any potential buyers or accessed when trading in the vehicle.

In another embodiment, as a vehicle is coming up to the end of a warranty period or a lease term, the dealership can engage a customer to see if they wish to obtain an extended warranty, and to make any other offers. For example, if a dealership knows that a vehicle has been well maintained by a customer, they may be more confident in offering a trade-in allowance towards a new vehicle, or to provide other incentives to keep the customer as a client for another vehicle.

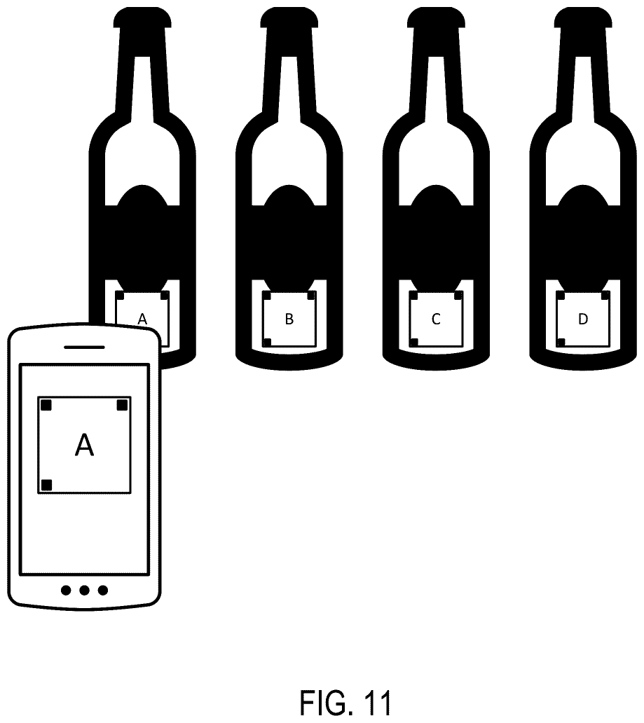

Now referring to FIG. 11, in another embodiment, the machine readable codes may be used on retail items for the purpose of anonymously targeting promotions to customers. For example, as shown in FIG. 11, a number of liquor bottles each have a unique machine readable code associated with a URL. By way of example, and not by way of limitation, the machine readable code may be a QR Code®, for example.

In an embodiment, when a customer purchases a bottle, the customer may bring home the bottle home and start by scanning the machine readable code. Upon scanning the code, the customer may be offered an incentive, for example to buy X more bottles in order to qualify for a free bottle. In order to qualify, the system may invite the customer to rescan the same barcode as the first bottle. When the customer is returned to the webpage, the customer may be invited to provide a proof-of-purchase of the second bottle, for example by scanning the machine readable code on the second bottle. This may be repeated until the customer has provided a proof-of-purchase for X+1 bottles, at which point the customer may be provided a downloadable coupon for the free bottle. In order to discourage cheating, various controls may be put in place, such as introducing a 15 minute delay between scans of machine readable codes that may be associated together to count towards an incentive, in order to prevent scanning of multiple bottles one after the other while at the liquor store. The system may also request that the customer take a photo of the product, and the tag or product code to verify or get additional information about the purchase. The system may also request a copy of the purchase receipt from the store showing the purchased item.

Here, the customer can remain completely anonymous to the system, and the system can still count the number of bottles (or any other product) required to qualify for the promotional offer. Moreover, even without collecting an email address or a telephone number, the webpage URL originally associated with the anonymous user can keep track of the items and offer the coupon via the URL. Advantageously, this allows promotional offers to be made on an anonymous basis without having to require reluctant customers share their personal information.

While bottles of liquor are described in an illustrative embodiment, it will be appreciated that any valuable consumer items may be tracked in an analogous manner, such as for example a set of kitchen appliances, or a set of power tools which a vendor wishes to promote. These set of items may be tracked as described above, and a vendor may offer a promotion or reward for a consumer that completes a set. This tracking may be anonymous as for the bottles of liquor, or the consumer may provide personal information on the online landing page which optionally identifies the consumer, for example for larger rewards for completing the purchase of a full set of kitchen appliances, or for purchasing a set of power tools. These are illustrative examples, and many other consumer products may be analogously tracked.

Thus, in an aspect, there is provided a computer-implemented method for dynamic assignment of machine readable codes for online information access, the method executable on a wireless network with access to the Internet, and comprising: (i) scanning a machine readable code; (ii) recognizing an account code; (iii) verifying an authorized system user associated with the account code; (iv) receiving instructions to activate the machine readable code; (v) receiving instructions to assign the machine readable code to a system user specified landing page; and (vi) activating a link from the machine readable code to the system user specified landing page upon request from the system user.

In an embodiment, the method further comprises: (vii) associating the machine readable code with one or more attributes; and (viii) tracking the one or more attributes associated with the machine readable code independently of the user specified landing page.

In another embodiment, the method further comprises: (xi) associating a secondary promotional page with the machine readable code; and (x) redirecting an end user to the promotional page to offer the end user a promotion which the end user can accept or refuse before the end user is directed to the system user specified landing page.

In another embodiment, the method further comprises associating the pre-printed machine readable code to a desired information landing page which is transparent to the end user.

In another embodiment, the method further comprises associating the pre-printed machine readable code to an online landing page accessible by multiple authorized parties to periodically update information about an item associated with the machine readable code.

In another embodiment, the pre-printed machine readable code is affixed to a vehicle and allow multiple authorized parties to access the maintenance history for the vehicle provided on the online landing page.

In another embodiment, the method further comprises associating the pre-printed machine readable code to an online landing page which tracks information about a consumer anonymously.

In another embodiment, the pre-printed machine readable codes are placed on valuable consumer items, and which allow a consumer to update information on an online landing page to associate multiple pre-printed machine readable codes on an online landing page.

In another embodiment, the online landing page provides a vendor the ability to track and promote the sale of multiple valuable consumer items to a consumer anonymously.

In another embodiment, the consumer items comprise valuable consumer items such as liquor, or a set of valuable consumer items such as kitchen appliances and power tools.

In another aspect, there is provided a system for dynamic assignment of machine readable codes for online information access, the system comprising one or more computing devices with a processor, memory, and storage, and a wireless network with access to the Internet, the system adapted to: scan a machine readable code; recognize an account code; verify an authorized system user associated with the account code; receive instructions to activate the machine readable code; receive instructions to assign the machine readable code to a system user specified landing page; and activate a link from the machine readable code to the system user specified landing page upon request from the system user.

In an embodiment, the system is further adapted to: associate the machine readable code with one or more attributes; and track the one or more attributes associated with the machine readable code independently of the user specified landing page.

In another embodiment, the system is further adapted to associate a secondary promotional page with the machine readable code; and redirect an end user to the promotional page to offer the end user a promotion which the end user can accept or refuse before the end user is directed to the system user specified landing page.

In another embodiment, the system is further adapted to associate the pre-printed machine readable code to a desired information landing page which is transparent to the end user.

In another embodiment, the system is further adapted to associate the pre-printed machine readable code to an online landing page accessible by multiple authorized parties to periodically update information about an item associated with the machine readable code.

In another embodiment, the pre-printed machine readable code is affixed to a vehicle and allow multiple authorized parties to access the maintenance history for the vehicle provided on the online landing page.

In another embodiment, the system is further adapted to associate the pre-printed machine readable code to an online landing page which tracks information about a consumer anonymously.

In another embodiment, the pre-printed machine readable codes are placed on valuable consumer items, and which allow a consumer to update information on an online landing page to associate multiple pre-printed machine readable codes on an online landing page.

In another embodiment, the online landing page provides a vendor the ability to track and promote the sale of multiple valuable consumer items to a consumer anonymously.

In another embodiment, the consumer items comprise valuable consumer items such as liquor, or a set of valuable consumer items such as kitchen appliances and power tools.

While various illustrative embodiments have been shown and described, it will be appreciated that the scope of the invention will be determined by the following claims.

1. A computer-implemented method for dynamic assignment of machine readable codes for online information access, the method executable on a wireless network with access to the Internet, and comprising:
(i) scanning a machine readable code;
(ii) recognizing an account code;
(iii) verifying an authorized system user associated with the account code;
(iv) receiving instructions to activate the machine readable code;
(v) receiving instructions to assign the machine readable code to a system user specified landing page; and
(vi) activating a link from the machine readable code to the system user specified landing page upon request from the system user.

2. The computer-implemented method of claim 1, further comprising:
(vii) associating the machine readable code with one or more attributes; and
(viii) tracking the one or more attributes associated with the machine readable code independently of the user specified landing page.

3. The computer-implemented method of claim 2, further comprising:
(xi) associating a secondary promotional page with the machine readable code; and
(x) redirecting an end user to the promotional page to offer the end user a promotion which the end user can accept or refuse before the end user is directed to the system user specified landing page.

4. The computer-implemented method of claim 2, further comprising associating the pre-printed machine readable code to a desired information landing page which is transparent to the end user.

5. The computer-implemented method of claim 2, further comprising associating the pre-printed machine readable code to an online landing page accessible by multiple authorized parties to periodically update information about an item associated with the machine readable code.

6. The computer-implemented method of claim 5, wherein the pre-printed machine readable code is affixed to a vehicle and allow multiple authorized parties to access the maintenance history for the vehicle provided on the online landing page.

7. The computer-implemented method of claim 2, further comprising associating the pre-printed machine readable code to an online landing page which tracks information about a consumer anonymously.

8. The computer-implemented method of claim 7, wherein the pre-printed machine readable codes are placed on valuable consumer items, and which allow a consumer to update information on an online landing page to associate multiple pre-printed machine readable codes on an online landing page.

9. The computer-implemented method of claim 8, wherein the online landing page provides a vendor the ability to track and promote the sale of multiple valuable consumer items to a consumer anonymously.

10. The computer-implemented method of claim 9, wherein the consumer items comprise valuable consumer items such as liquor, or a set of valuable consumer items such as kitchen appliances and power tools.

11. A system for dynamic assignment of machine readable codes for online information access, the system comprising one or more computing devices with a processor, memory, and storage, and a wireless network with access to the Internet, the system adapted to:
scan a machine readable code;
recognize an account code;
verify an authorized system user associated with the account code;
receive instructions to activate the machine readable code;
receive instructions to assign the machine readable code to a system user specified landing page; and
activate a link from the machine readable code to the system user specified landing page upon request from the system user.

12. The system of claim 11, wherein the system is further adapted to:
associate the machine readable code with one or more attributes; and
track the one or more attributes associated with the machine readable code independently of the user specified landing page.

13. The system of claim 12, wherein the system is further adapted to:
associate a secondary promotional page with the machine readable code; and
redirect an end user to the promotional page to offer the end user a promotion which the end user can accept or refuse before the end user is directed to the system user specified landing page.

14. The system of claim 12, wherein the system is further adapted to associate the pre-printed machine readable code to a desired information landing page which is transparent to the end user.

15. The system of claim 12, wherein the system is further adapted to associate the pre-printed machine readable code to an online landing page accessible by multiple authorized parties to periodically update information about an item associated with the machine readable code.

16. The system of claim 15, wherein the pre-printed machine readable code is affixed to a vehicle and allow multiple authorized parties to access the maintenance history for the vehicle provided on the online landing page.

17. The system of claim 12, wherein the system is further adapted to associate the pre-printed machine readable code to an online landing page which tracks information about a consumer anonymously.

18. The system of claim 17, wherein the pre-printed machine readable codes are placed on valuable consumer items, and which allow a consumer to update information on an online landing page to associate multiple pre-printed machine readable codes on an online landing page.

19. The system of claim 18, wherein the online landing page provides a vendor the ability to track and promote the sale of multiple valuable consumer items to a consumer anonymously.

20. The system of claim 19, wherein the consumer items comprise valuable consumer items such as liquor, or a set of valuable consumer items such as kitchen appliances and power tools.
